(19) United States
(12) Patent Application Publication
(10) Pub. No.: US 2019/0078684 A1
(43) Pub. Date: Mar. 14, 2019

(54) METHOD FOR CHECKING THE CONFIGURATION SAFETY OF A COUPLING DEVICE

(71) Applicant: Renault s.a.s, BOULOGNE-BILLANCOURT (FR)

(72) Inventors: Adrien CHAMEROY, Voisins-Le-Bretonneux (FR); Cédric CHANTREL, Charenton Le Pont (FR)

(21) Appl. No.: 16/082,949

(22) PCT Filed: Jan. 25, 2017
(86) PCT No.: PCT/FR2017/050168

§ 371 Date: Sep. 7, 2018

(30) Foreign Application Priority Data
Mar. 10, 2016 (FR) 1652009

(51) Int. Cl. F16H 61/28; F16H 63/50; F16H 59/68; F16H 61/04; F16H 61/12

(52) U.S. Cl. CPC F16H 61/2807; F16H 63/50; F16H 59/68; F16H 61/0403; F16H 2306/48; F16H 2059/6823; F16H 2061/0422; F16H 2061/122; F16H 61/12

(57) ABSTRACT

A method is provided for checking a configuration safety of a coupling device for a gear box sliding gear. The gear box sliding gear is rotationally connected to a drive input shaft of the gearbox and is axially movable on the drive input shaft from an intermediate neutral position to either of two opposite positions of engagement with an idler pinion. The method defining a neutral configuration of the coupling device on based on a main information relating to the position of the slider gear and its movement setting, in which position the transmission of the torque to the wheel is effectively stopped, and in that the start of synchronization of the slider gear with a pinion is only allowed when the device is in this configuration.

### CROSS-REFERENCE TO RELATED APPLICATIONS

This application is a U.S. national stage application of International Application No. PCT/FR2017/050168, filed on Jan. 25, 2017, which claims priority to French Patent Application No. 1652009, filed on Mar. 10, 2016.

### BACKGROUND

The present invention relates to checking transmissions, with regard to the operational safety and comfort of gear changes made via dog clutch, or claw clutch sliding gears, without mechanical synchronizers, in transmissions where the synchronization of the pinions on their shaft is ensured by appropriate control of the drive sources.

### SUMMARY

More precisely, its subject matter is a method for checking the configuration safety of a gearbox coupling device rotationally rigidly connected to a movement input shaft thereof, and axially movable on this shaft on each side of an intermediate neutral position, between two opposite positions, of engagement with an idler pinion.

This invention finds a preferred, but not restrictive, application on hybrid powertrains, having multiple drive sources, in particular a combustion engine and one, or more, electrical machines.

In most road vehicles, the transmission of energy from the powertrain to the wheel, takes place through a gearbox with multiple configurations. Changing from one configuration to another, requires the synchronization of different elements of the box. Between two engaged ratio positions, the coupling devices of the pinions have a “neutral configuration”, in which the transmission of energy between the powertrain and the wheel is cut off.

When the coupling devices are provided with integrated mechanical synchronization means, these means themselves ensure the synchronization of a sliding gear with a pinion, during its displacement toward the pinion.

When synchronization of the pinions is not ensured by an integrated mechanical synchronization system, it may be ensured through an appropriate control of the powertrain motors/engines. In any case, it is sought to minimize the impact of synchronization on road behavior.

When synchronization takes place on the basis of speed regulation, it is necessary to safely ensure that the energy mobilized for this synchronization is not transmitted to the wheel.

The object of the present invention is to ensure that the synchronization phase is performed in the absence of torque transmitted to the wheel.

With this object, the invention provides for defining a neutral configuration of the coupling device according to a main piece of information on the position of the displacement device and the displacement setting thereof, in which position the transmission of the torque to the wheel is effectively interrupted, and for enabling the start of synchronization of the sliding gear with a pinion, only when the device is in this configuration.

Preferably, a redundant piece of position information, is used for making the neutral configuration safe.

### BRIEF DESCRIPTION OF THE DRAWINGS

The present invention will be better understood from reading the following description of a particular, non-restrictive, embodiment thereof, with reference to the appended drawings, in which:

FIG. 1 is a simplified representation of a vehicle kinematic chain,

FIG. 2 is a general diagram of the method provided,

FIG. 3A through 3D depict different relative positions of the dogs of the sliding gear and of the pinion, and

FIGS. 4A and 4B are sequencing timing diagrams.

### BRIEF DESCRIPTION OF THE DRAWINGS

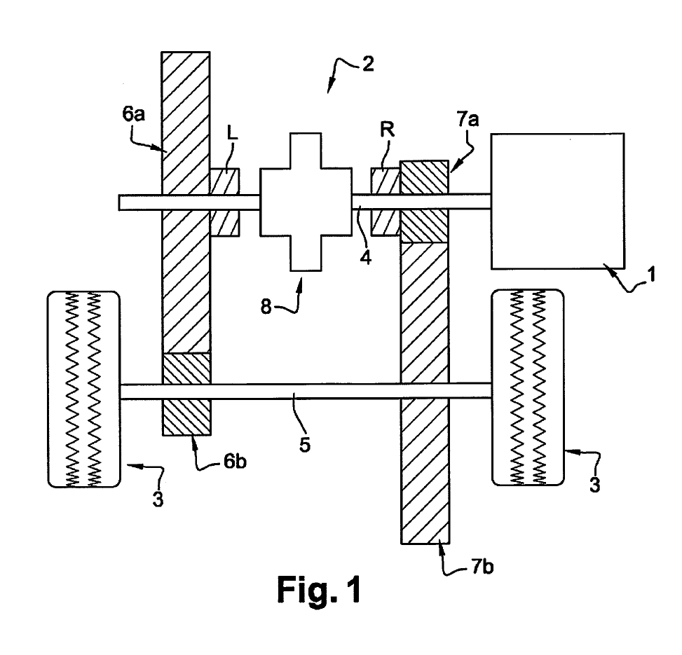

FIG. 1 schematically represents the simplified kinematic chain of a vehicle, between its drive motor/engine 1, its gearbox 2, and its wheels 3. The movement enters the box via an input shaft 4, and emerges via an output shaft 5 connected to the wheels 3. It descends from the input shaft 4 onto the output shaft 5, via one or other of two gear downshifts 6a, 6b; 7a, 7b, defining two different transmission ratios. The coupling device 8, also known as a claw clutch, or dog clutch sliding gear, is rotationally rigidly connected to the movement input shaft 4. This coupling device is axially movable on this shaft, on each side of an intermediate neutral position, between two opposite positions of engagement on one of the two speed pinions or idler pinions 6a, 7a, which are axially immovable on the shaft 4. The coupling device 8 has two configurations of engagement L and R, depending on the position of the sliding gear.

The method of the invention checks the position of such a coupling device. It intentionally makes use of two pieces of redundant information, making it possible to estimate the configuration of the device. The main piece of information F is a continuous variable between the limits Min and Max, and centered on zero. It is representative of the position of the coupling device. The second piece of information, FR which is redundant, and summary, with respect to the first, takes two possible states: a Neutral state Or a Non-neutral state.

Preliminary analysis of the device highlights the following risk. If the synchronization is performed while the coupling system is coupled, the powertrain is controlled in order to reach a fixed speed, regardless of the driver's intention. During the transitional phases, this control may lead to unwanted acceleration, or to unwanted deceleration. When the speed is stabilized, the powertrain no longer meets the deceleration requirements.

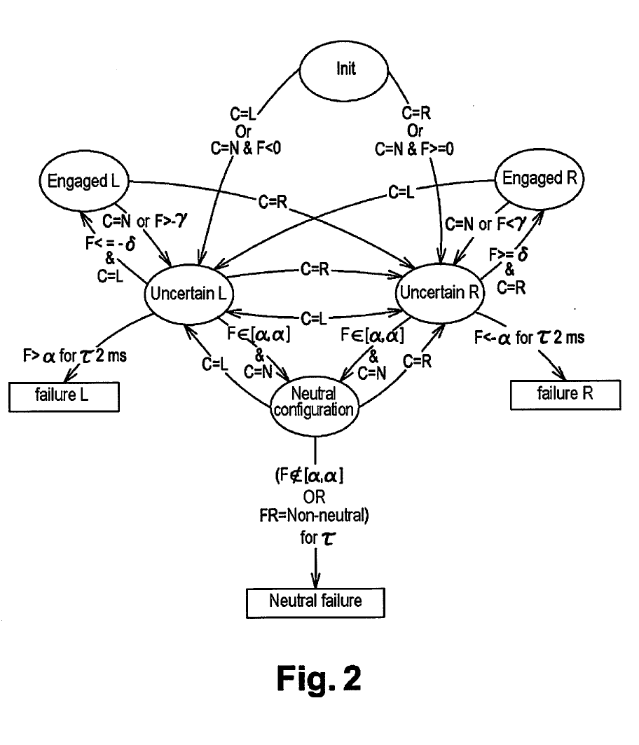

In the diagram in FIG. 2, different states of the coupling device are defined, accessible from an initial state “init”, according to the values taken by:
a main piece of position information F of the device, centered on 0 in neutral,
a piece of intentionally redundant position information of the device FR, taking the values 0 in neutral and 1 outside neutral, and
the displacement setting C of the device.

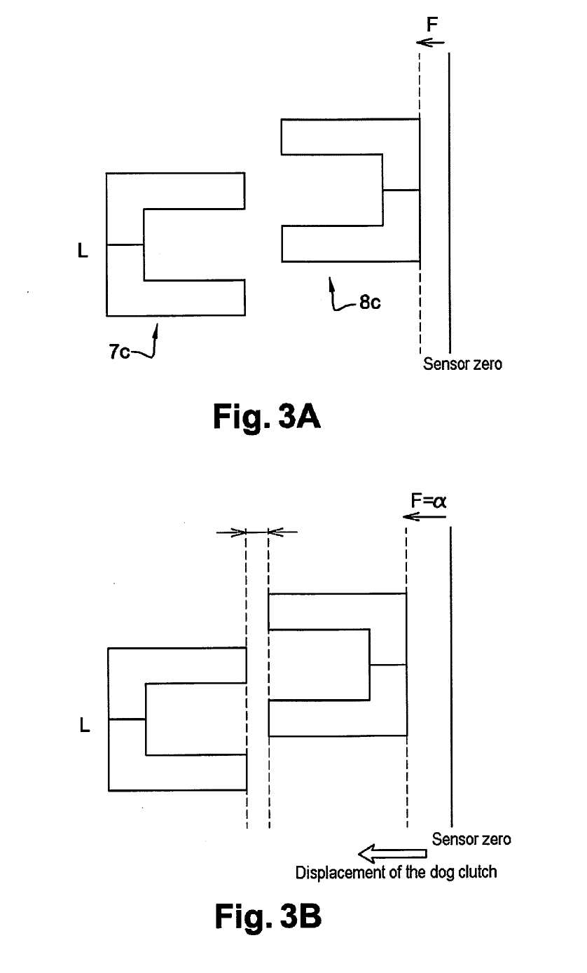

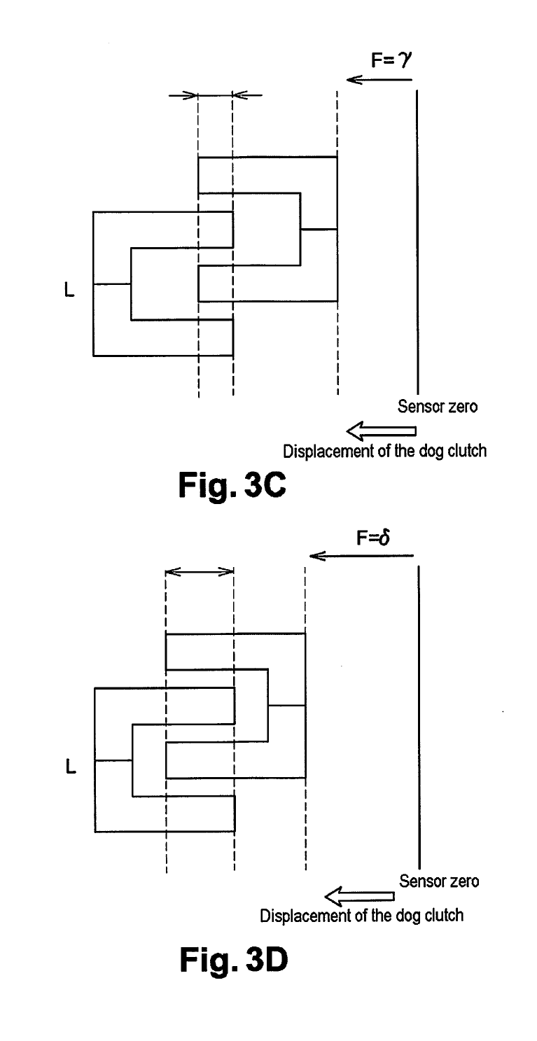

The diagram in FIG. 2 refers to four particular positions of the device, corresponding to values 0, α, γ and δ of F, according to the relative position of the claws or dogs 8c of the sliding gear, with respect to the fixed teeth (dogs or claws) 7c of the idler gear, which are illustrated in FIGS. 3A through 3D:

FIG. 3A corresponds to the neutral position: F=0.

In FIG. 3B, F=α, applicative value of F defining the distance d_{b} between −α and +α where no torque is transmitted to the wheels.

In FIG. 3C F=γ, applicative value of F detecting a problem of engagement, in which the overlap d_{c} of the dogs is insufficient for ensuring the engagement of the ratio.

In FIG. 3D, F=δ, applicative value of F, where the overlap d_{d} is sufficient for ensuring the engagement of a ratio.

The initial position “init” in FIG. 2 is by definition unknown. The neutral configuration of the coupling device is defined according to the main piece of position information F of the sliding gear, and its displacement setting C when the transmission of the torque to the wheel is effectively interrupted. The engagement setting of the left ratio is denoted by L (C=L); the engagement setting of the right ratio is denoted by R (C=L).

The device passes through a state of uncertain engagement, when sending an engagement setting R, L or when sending a neutral setting N with a piece of main non-neutral information F. The engagement setting L, C=L, or the neutral setting C=N, associated with a negative piece of position information F<0, places the device in a leftward uncertain engagement state “Uncertain L”. Similarly, C=R, or [C=N and F>=0], places the device in a state of rightward uncertain engagement “Uncertain R”. “Uncertain R” changes to “Engaged R” with a setting C=R, if F>δ. Similarly, “Uncertain L” changes to “Engaged L” with the setting C=L, if F<−δ and C=L. “Engaged L” changes back into “Uncertain L” if C=Nor F>−γ; “Engaged R” changes back into “Uncertain R” if C=N or F<γ. The change from “Uncertain L” to “Uncertain R” follows a setting C=R; the reverse change follows a setting C=L. The neutral configuration sought, or “Safety neutral”, is reached, either from “Uncertain L” with the setting C=N and α<F<α, or from “Uncertain R” with the setting C=N and −α<F<α. Conversely, the safety neutral changes back into the uncertain states, with the settings C=L or C=R.

Thus:

the neutral configuration is determined, when the setting C is in neutral, and the main piece of position information F is in the zone [−α, +α] making it possible to ensure that no torque is transmitted,

a change of the coupling device, from a state of uncertain engagement to an engaged state (R, L) is detected, if the main piece of position information takes an applicative value (δ) ensuring engagement, and

conversely, a change of the device, from an engaged state (R, L) to a state of uncertain engagement is detected, if the main piece of position information takes an applicative value (γ) ensuring non-engagement.

In conformity with the invention, starting the synchronization of the sliding gear with one of the two pinions 6a, 7a, with a view to engaging a ratio is enabled, when the coupling device is in the neutral configuration. The method takes into account two particular durations τ and −τ₂, respectively the confirmation time of leaving safety neutral, and the confirmation time of the uncertain states: a failure of the coupling device is detected if the main piece of position information (F) remains outside [−α, +α] after a confirmation time τ₂, of the uncertain states.

The neutral configuration is made safe by a piece of redundant information FR on the neutral, or non-neutral, configuration of the device. Maintaining the piece of redundant information FR at its non-neutral value for a confirmation time τ, while the coupling device is in neutral configuration, determines a failure of the neutral state. A failure of the neutral position (“Safety neutral failure”) is detected if F<−α or F>α for the confirmation duration τ, or if the piece of redundant information FR changes to “non-neutral” for the confirmation duration τ. This failure may also be detected by the main piece of position information being maintained outside a zone [−α, α+] making it possible to ensure that no torque is transmitted. In any case, the failure state involves stopping synchronization.

Furthermore, a left failure (“Undefined (L) Failure”) is detected if F>α for τ₂, from “Uncertain L”, or a right failure (“Undefined (R) Failure”) is detected from “Uncertain R” if F<−α for τ₂.

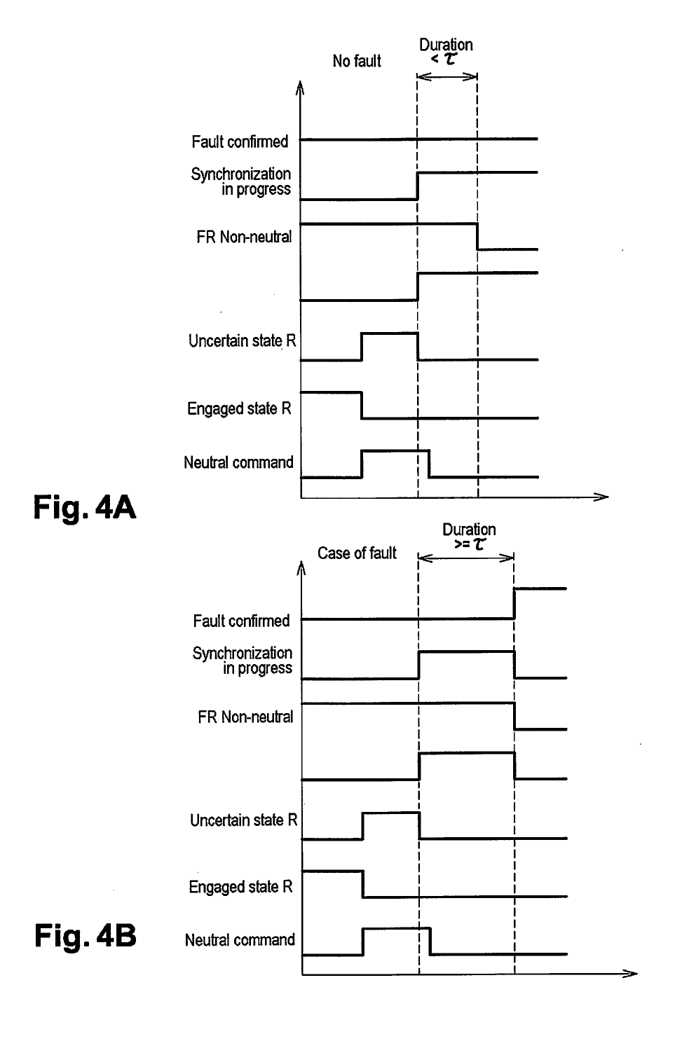

FIG. 4A illustrates the sequencing of the method, without failure confirmation. At to, the date of the neutral command, the coupling device leaves the “R engaged” state to change to “Uncertain R”. Synchronization effectively begins at t₁, when the neutral configuration is reached. The neutral command is abandoned after t₁. The redundant information FR changing to neutral, confirms the neutral configuration.

In FIG. 4B, failure is confirmed at the end of the time τ, of confirmation of leaving the neutral configuration, measured from the start of synchronization t₁. As mentioned above, a failure of the neutral configuration is detected, if the main piece of position information F remains outside the range (−α, +α), after the confirmation time of the uncertain states 12.

In summary, the configuration taken into account for checking the powertrain, and triggering synchronization, is obtained from the main piece of information F and the desired position (the setting C). As soon as the main piece of information F indicates a neutral configuration, synchronization may start. The redundant piece of information F is used for making the neutral configuration safe. The change into the neutral failure state, makes it possible to trigger, after a confirmation time, the safety procedure for placing the vehicle in a safe state, e.g. for stopping synchronization.

The invention has many advantages. In particular, it makes it possible to minimize, with a high level of safety, the impact of synchronization on the road behavior of a vehicle, to avoid unwanted accelerations or decelerations, while maximizing driving comfort.

The constraints on the system for checking the gearbox are limited, since the piece of redundant information FR may be less accurate and slower than the main piece of position information F. Thanks to the invention, safety requirements in a gearbox architecture with synchronizations regulated by motor/engine control are observed without a complex system.

1. A method for checking a configuration safety of a sliding gear gearbox for a coupling device that is rigidly connected in a rotational direction to a movement input shaft to rotate together in the rotational direction, and that is axially movable on the movement input shaft in opposite axial directions from an intermediate neutral position to opposite engagement positions in which the coupling device is engaged with an idler pinion, the method comprising:
defining a neutral configuration of the coupling device in which position transmission of torque to a wheel is effectively interrupted based on a main piece of position information of the sliding gear, and a displacement setting of the sliding gear,
using a piece of redundant information indicating one of a neutral state and a non-neutral state of the coupling device,
enabling a starting of the synchronization of the sliding gear with a pinion only upon determining the coupling device is in the neutral configuration based on the main piece of position information and the piece of redundant information.

2. The method for checking as claimed in claim 1, further comprising
passing the coupling device through a state of uncertain engagement, when sending one of an engagement setting and a neutral setting with a piece of main non-neutral information.

3. The method for checking as claimed in claim 2, further comprising
determining the neutral configuration exists, when the neutral setting, and the main piece of position information is in a prescribed zone that ensures no torque is transmitted.

4. The method for checking as claimed in claim 1, further comprising
determining a failure of the neutral configuration by maintaining the piece of redundant information at a non-neutral value for a confirmation time, while the coupling device is in the neutral configuration.

5. The method for checking as claimed in claim 4, further comprising
detecting the failure of the neutral configuration is by the main piece of position information being maintained outside a prescribed zone that ensures no torque is transmitted.

6. The method for checking as claimed in claim 4, further comprising
stopping synchronization upon determining the failure of the neutral configuration.

7. The method for checking as claimed in claim 2, further comprising
detecting a change of the coupling device from a state of uncertain engagement to an engaged state upon determining the main piece of position information takes an applicative value ensuring engagement.

8. The method for checking as claimed in claim 2, further comprising
detecting a change of the coupling device from an engaged state to a state of uncertain engagement upon determining the main piece of position information takes an applicative value ensuring non-engagement.

9. The method for checking according to claim 1, further comprising
detecting a failure of the coupling device upon determining the main piece of position information remains outside a prescribed zone after a confirmation time of uncertain states.
